(19) United States
(12) Patent Application Publication
(10) Pub. No.: US 2025/0042224 A1
(43) Pub. Date: Feb. 6, 2025

(54) HEATING DEVICE FOR VEHICLE INTERIOR

(71) Applicant: VALEO SYSTEMES THERMIQUES, Le Mesnil-Saint-Denis (FR)

(72) Inventors: Vincent Feuillard, Le Mesnil-Saint-Denis (FR); Nicolas Devienne, Le Mesnil-Saint-Denis (FR); Alexandre Weil, Le Mesnil-Saint-Denis (FR); Alexandre Paschutine, Le Mesnil-Saint-Denis (FR)

(73) Assignee: VALEO SYSTEMES THERMIQUES, Le Mesnil-Saint-Denis (FR)

(21) Appl. No.: 18/718,722

(22) PCT Filed: Dec. 1, 2022
(86) PCT No.: PCT/EP2022/084139

§ 371 Date: Jun. 11, 2024

(30) Foreign Application Priority Data
Dec. 16, 2021 (FR) 2113611

(51) Int. Cl. B60H 1/22; H05B 3/03; H05B 3/34

(52) U.S. Cl. CPC B60H 1/2226; H05B 3/03; H05B 3/342; H05B 2203/006; H05B 2203/013

(57) ABSTRACT

A heating device configured to be installed in a motor vehicle interior includes a heating structure and an electrical connector. The heating structure includes a resistive layer configured to produce a release of heat when the resistive layer has an electric current passing through it. The heating structure also includes at least two distribution electrodes that are in electrical contact with the resistive layer to allow an electric current to flow through the resistive layer. The electrical connector includes at least two electrical-contact regions. One of the electrical-contact regions is in electrical contact with one of the distribution electrodes. The other electrical-contact region is in contact with the other distribution electrode. The electrical connector includes an edge extending from one of the electrical-contact regions towards the other electrical-contact region.

### TECHNICAL FIELD

The present invention relates to the field of heating devices intended to equip vehicle, for example motor vehicle, interiors.

A radiant panel comprises a plurality of electrodes designed to provide heat through Joule heating by supplying an electric current to a conductive coating. Reference may be made, for example, to document US2016/0059669.

A radiant panel is a device generally comprising an electrical circuit designed to provide heat through Joule heating by supplying an electric current, via electrically conductive parts, to resistive conductive elements. According to the existing literature, the conductive coating may be for example a coat of paint comprising carbon particles and/or metal particles.

Various types of metallic connectors intended to connect an electrical power supply and an electrically conductive part are known from the prior art. These connectors cover various applications such as automotive or domestic applications.

The prior art describes heating devices comprising heating structures in which a conductive track, notably a distribution electrode, is connected to an electrical connector configured to connect said conductive track to an electrical power source. It is therefore necessary to use as many electrical connectors as the heating structure has conductive tracks.

One of the objectives of the present invention is therefore to overcome the disadvantages of the prior art by proposing a heating device comprising a heating structure such as a radiant panel and an electrical connector which is capable of connecting several conductive tracks, so as to reduce the bulk of the heating device and improve the haptics thereof.

### SUMMARY

To this end, one subject of the invention is a heating device intended to be installed in a vehicle, notably a motor vehicle, interior, and comprising:
a heating structure comprising:
   at least one resistive layer designed to produce a release of heat when this layer has an electric current passing through it,
   at least two distribution electrodes, said distribution electrodes being in electrical contact with the resistive layer so as to allow an electric current to flow through the resistive layer,
an electrical connector comprising at least two electrical-contact regions, one of the regions being in contact with one of the distribution electrodes, the other region being in contact with the other distribution electrode, the electrical connector comprising an edge extending from one of the electrical-contact regions towards the other electrical-contact region.

Thus, advantageously, the heating device comprises a single electrical connector for connecting each of the two distribution electrodes. The heating device is therefore less bulky and offers improved haptics.

In one aspect according to the invention, the electrical connector is made in one piece.

According to one of the aspects of the invention, at least one of the distribution electrodes is rectilinear over at least part of its length, and contact electrodes are associated with this distribution electrode and are connected, for example perpendicularly, to this distribution electrode.

Naturally, the distribution electrodes may have different shapes, in particular curved with rounded portions. The distribution electrodes may or may not be mutually parallel.

According to one of the aspects of the invention, the electrode array comprises at least two distribution electrodes which are mutually parallel over at least part of their length, and their associated contact electrodes are arranged between these two distribution electrodes and alternate with an inter-electrode distance which decreases in accordance with the decrease in voltage present between the pairs of electrodes, so as to maintain a substantially uniform electrical power between the pairs of contact electrodes.

According to one of the aspects of the invention, the contact electrodes arranged between two distribution electrodes form part of one and the same group of contact electrodes, said group have only two inter-electrode distance values or at least three or more inter-electrode distance values.

According to one of the aspects of the invention, the resistive layer is a layer deposited on a substrate in particular by screen printing, this resistive layer extending in particular between the two distribution electrodes associated with the group of contact electrodes.

According to one of the aspects of the invention, the resistive layer comprises in particular carbon.

According to one of the aspects of the invention, the electrodes are made of conductive material, in particular a metallic material, such as ink filled with conductive particles, in particular particles of silver or of copper. If desired, the electrodes are adhesive metal strips, for example made of copper. Where applicable, these electrodes may possibly be formed by deposition of a material on the substrate.

According to one of the aspects of the invention, the resistive layer associated with the group of contact electrodes is a continuous layer, or as a variant comprises a plurality of discrete resistive elements forming this layer.

According to one of the aspects of the invention, the contact electrodes of one and the same group have the same length.

According to one of the aspects of the invention, the heating structure comprises a substrate which carries the resistive layer and the electrodes. The substrate preferably has a thickness of less than 1 cm for a surface area of at least several cm².

The invention further relates to a component of a motor vehicle interior, in particular a component to be integrated into a vehicle door, or in particular parts of the dashboard, the footwell trim, the headlining, the armrest, comprising a heating structure, in particular a radiant panel, as described above.

According to one of the aspects of the invention, the vehicle-interior component which comprises the heating structure, for example the radiant panel, is designed to heat by thermal radiation (radiant panel) or by thermal conduction or thermal contact (contact heating structure), and not by convection heating, for example by heat carried by moving air. In particular, no air flow intended for cooling or heating the vehicle interior passes through the heating structure. Preferably, the panel is disconnected from the air circulation system.

The heating structure and the HVAC system of the vehicle may, if desired, be controlled in coordinated fashion.

The component forms, for example, an element of a glove compartment or door panel of the vehicle, or the roof of the vehicle interior.

According to another aspect of the invention, the heating structure has a resistive layer and electrodes for heating this layer, this structure being designed to be integrated into a vehicle-interior component which comprises a trim element visible from inside the vehicle interior, this trim element being, for example, vehicle-interior trim lining, such as for example a fabric, a leather or an aesthetic covering.

In one aspect of the invention, the heating structure comprises at least one resistive layer designed to produce a release of heat when this layer has an electric current passing through it, this structure further comprising an electrode array comprising a plurality of contact electrodes arranged so as to be in electrical contact with the resistive layer in order to cause electric current to flow through this resistive layer, the contact electrodes and the resistive layer are borne on a substrate made of a flexible material capable of taking a predetermined shape through deformation, this substrate being in particular also stretchable. In particular, the elements of the heating structure form a stretchable assembly, in other words the substrate, the resistive layer and the contact electrodes are stretchable and flexible.

In one aspect according to the invention, the heating structure is a radiant panel.

According to one of the aspects of the invention, the contact electrodes are formed by intermeshed, in particular woven or knitted, filaments, on or in a respectively woven or knitted substrate. The conductive filaments forming the contact electrodes are in contact with the resistive layer.

According to one of the aspects of the invention, the substrate is a non-woven. This non-woven may comprise a mixture of polypropylene fibres and/or polyester fibres. Other fibres may be used, for example natural fibres.

As a variant, the substrate is a fabric, in particular with stretchable filaments, or a knitted structure.

According to one of the aspects of the invention, the substrate may be a flexible plastic sheet or a foam such as TPU (thermoplastic polyurethane) foam.

Advantageously, in order to remain substantially invisible and/or imperceptible, the contact electrodes and/or the resistive layer must be sufficiently thin, in particular with a thickness of less than 100 microns, and must be flexible. These electrodes and the resistive layer may comprise a stretchable conductive ink and/or be inside the substrate.

According to one of the aspects of the invention, the resistive layer may comprise a stretchable resistive sheet, a coat of resistive paint or a resistive ink. The resistive sheet is a sheet capable of releasing heat when an electric current passes through it.

According to one of the aspects of the invention, the conductive ink may be added to the substrate by screen printing, offset printing, inkjet printing, hot stamping and transfer, or electrodeposition.

According to one of the aspects of the invention, the substrate may be a vehicle-interior decorative element, in particular an element visible to passengers in the vehicle interior. This type of decorative substrate may be chosen from: a leather or imitation leather substrate, containing in particular PVC, a textile which may or may not be of 3D type, or a decorative plastic film.

In one aspect according to the invention, the heating structure comprises a collection of intermeshing filaments of which some filaments form heating conductive filaments designed to produce heat when an electric current passes through these heating filaments.

In one exemplary embodiment of the invention, the substrate may be a stretchable textile which incorporates filaments as heating material. Alternatively, the substrate may be a stretchable textile or a stretchable knit which incorporates filaments used as contact electrodes and the resistive layer is placed on the surface. The resistive ink is attached, for example, to the textile by lamination, screen printing or hot stamping and transfer.

The substrate may be a knitted structure with at least one of the following filaments: non-stretchable filaments for the substrate, non-stretchable conductive filaments for electrodes, single-stranded or multi-stranded copper filaments, a copper conductive filament, and non-conductive filaments for reasons of mechanical strength or ease of manufacture.

The knitted structure has the advantage that, even if the support filament and the conductive filament which forms, for example, an electrode are not stretchable, the structure of the knit stitch makes the knitted structure stretchable. With a non-stretchable copper filament, the extensibility of the knit is about 14% for example.

According to one of the aspects of the invention, the heating structure comprises an electrical distribution circuit comprising distribution electrodes which carry the current from the connectors to the contact electrodes which are in contact, for example, with a resistive layer.

The contact and distribution electrodes are, for example, made of copper filaments.

When the substrate is woven, the stretchable characteristic may be obtained either through the arrangement of the woven structure, namely through the weaving technique, or through the intrinsic stretchability of the filaments used for the weaving.

In particular, if the extensibility of the conductive filament is different from that of the main fibres of the fabric, the end of each conductor must remain free to move inside or outside the fabric.

If a plurality of contact electrodes are connected together to one of the distribution electrodes, the connection between the distribution electrode and the contact electrodes may be made by integrating the distribution electrode into the weaving weft and the contact electrodes into the weaving warp or vice versa. By virtue of an alternating passage on the two sides of the woven structure, the connection between electrodes is secure.

In order to have a continuous manufacturing process for the knitted or woven structure, it is possible to connect the two sides of the contact electrodes to the distribution electrodes and then to electrically neutralize a portion of these contact electrodes with respect to the distribution electrode by cutting the filaments of the contact electrodes by stamping them in a stamped region, or by incorporating an electrical insulator at the location where the electrical connection is to be interrupted in an interrupted region.

Alternatively, it is possible to have a connector at the end of each contact electrode, or an external distribution electrode connecting all of the contact electrodes together.

The invention further relates to a method for manufacturing a heating structure, comprising the steps of weaving or knitting a substrate and of providing, on the substrate, heating or radiant regions formed by filaments woven or knitted in with the substrate, or by depositing a resistive layer on the substrate.

The invention makes it possible, for example, to provide a heating structure forming a decorated part of the inside of a motor vehicle, this part being of complex shape. These complex surfaces may have curvatures along the axes in all three dimensions.

In a disadvantageous approach, not using the invention, the surface may be decorated with a layer of plastic film, leather or textile which makes any roughness or deficiency in the thickness of the surface visible. This leads to an impression of poor quality in the design of the part.

One problem with this approach is that an interposition of a smoothing material between the heating structure and the decorative surface results in thermal insulation which reduces the temperature of the decorative surface and thus reduces the heating power provided to the vehicle-interior environment.

The electrical power needed for sufficient heating power (for example higher than 500 W/m²) to give a positive feeling of comfort under a low voltage (for example lower than 50 volts) requires conductive lines of sufficient cross section which are difficult to conceal behind a decorative layer.

The invention makes it possible to have a heating structure that both exhibits a very low level of thickness defects and is stretchable so as to conform to the complex shape while remaining substantially imperceptible.

In one aspect according to the invention, the electrical connector is mounted on the heating structure.

Advantageously, the electrical connector is mounted on the substrate of the heating structure.

In one aspect according to the invention, the heating structure comprises a temperature sensor designed to contribute to measuring the temperature of at least one region of the heating structure.

In one aspect according to the invention, the temperature sensor is in contact with the resistive layer.

In one aspect according to the invention, the temperature sensor is secured to the substrate.

According to one of the aspects of the invention, the temperature sensor comprises a measurement layer extending in the region where the temperature is to be measured, and this measurement layer has an electrical resistance which is variable as a function of the temperature of the region.

The invention thus allows temperature control over the entire heating surface, in real time, in the desired region or regions. By measuring the resistance on the measurement layer, it is possible to obtain an image of the temperature of the resistive layer.

According to one of the aspects of the invention, the temperature sensor has an electrical resistance which varies as a function of the temperature. Thus, the temperature sensor is arranged to allow access to a measurement of temperature in said region of the heating structure by measuring the electrical resistance of the temperature sensor, which resistance is a function of the temperature in said region of the heating structure.

According to one of the aspects of the invention, this measurement layer is made of a material with an NTC (negative temperature coefficient) effect or a material with a PTC (positive temperature coefficient) effect.

According to one of the aspects of the invention, the NTC material has the feature whereby its electrical resistance drops when the temperature increases. The material may comprise, for example, a semiconductive silicone.

According to one of the aspects of the invention, the PTC material has the feature whereby its electrical resistance increases when the temperature increases. In particular, the increase in resistance may jump when a threshold temperature is reached. The PTC material may for example comprise a carbon-based paint.

According to one of the aspects of the invention, the temperature sensor, in particular the measurement layer, covers at least 10%, in particular at least 20%, or 30% or 40% of the surface area of the heating structure, in particular of the surface area of the substrate.

According to one of the aspects of the invention, the temperature sensor, in particular the measurement layer, covers at least 10%, in particular at least 20%, or 30% or 40% of the surface area of the heating structure, in particular of the surface area of the resistive layer.

According to one of the aspects of the invention, the measurement layer extends over a region of the heating structure which is likely to heat up, in particular the measurement layer is arranged in thermal interaction with the resistive layer in such a way as to measure the temperature of at least some regions of this resistive layer.

According to one of the aspects of the invention, the measurement layer, which is a surface layer, extends mainly facing the resistive layer, in particular the measurement layer is facing the resistive layer over at least 90% of the surface area of the measurement layer.

According to one of the aspects of the invention, the measurement layer has a thickness which is sufficiently thin so as not to impair the perceived visual or haptic quality of the surface once decorated for visible panels of the inside of a vehicle.

For example, the thickness of the measurement layer is between 10 microns and 200 microns, in particular between 40 and 200 microns.

According to one of the aspects of the invention, the measurement layer has a shape selected for measuring the temperature of the resistive layer in regions likely to heat up the most in the operation of this resistive layer.

According to one of the aspects of the invention, the measurement layer has a shape with at least one direction-change bend, in particular several bends.

According to one of the aspects of the invention, the measurement layer has a serpentine shape.

According to one of the aspects of the invention, the measurement layer takes the form of a plurality of serpentine bends.

According to one of the aspects of the invention, the measurement layer has at least one rectilinear section, in particular several rectilinear sections.

According to one of the aspects of the invention, the measurement layer has branches.

According to one of the aspects of the invention, the temperature sensor is electrically insulated from the resistive layer, in particular by an insulating layer or an insulating sheet.

According to one of the aspects of the invention, the heating structure comprises a substrate, in particular a textile, thermoplastic, non-woven substrate, on which is present the measurement layer produced in particular by printing, screen printing or lamination of a material, in particular a PTC or NTC material.

As a variant, the measurement layer comprises a film of material, in particular a laminated material.

As a further variant, the heating structure comprises a textile substrate, in particular woven or knitted substrate, on which filaments having NTC or PTC properties are knitted/embroidered/sewn.

In one example of implementation of the invention, the serpentine-shaped measurement layer is inserted in thermal contact with the resistive layer likely to heat up.

According to one of the aspects of the invention, the resistive layer is present on one face of the substrate, and the temperature sensor is present on an opposite face of the substrate.

According to one of the aspects of the invention, the resistive layer and the temperature sensor are present on one and the same face of the substrate.

In this case, the structure preferably comprises an insulator between the resistive layer and the temperature sensor.

As a variant, the temperature sensor comprises a thermocouple, or in particular a temperature probe formed by an added component.

In one aspect according to the invention, the temperature sensor comprises at least two electrical terminals configured to connect said temperature sensor to a measurement circuit designed to supply temperature information.

In one aspect according to the invention, said measurement circuit comprises an electrical source of positive polarity and an electrical source of another polarity which may be connected to earth potential.

In one aspect according to the invention, the electrical terminals comprise electrically conductive filaments.

In one aspect according to the invention, the electrical terminals comprise electrically conductive plates.

In one aspect according to the invention, the electrical connector comprises at least two additional electrical-contact regions, one of these additional electrical-contact regions being in contact with one of the electrical terminals of the temperature sensor, the other additional electrical-contact region being in electrical contact with the other electrical terminal of the temperature sensor.

In one aspect according to the invention, the electrical connector comprises at least two electrical-contact regions, one of these electrical-contact regions being in contact with one of the distribution electrodes, another of these electrical-contact regions being in contact with the other distribution electrode, and at least two additional electrical-contact regions, one of these additional electrical-contact regions being in contact with one of the electrical terminals of the temperature sensor, the other of these additional electrical-contact regions being in electrical contact with the other electrical terminal of the temperature sensor.

In one aspect according to the invention, the electrical connector is designed to fit-together with at least one complementary connector that complements said electrical connector, for example a plug.

In one aspect according to the invention, the electrical connector comprises at least two connecting members which are configured to provide connection to the electrical power supply network, for example of a motor vehicle, such as a battery.

In one aspect according to the invention, the electrical connector comprises four connecting members intended to be brought into electrical contact with at least four complementary electrically conductive members comprised in at least one complementary electrical connector so as to make the connection with the electrical power supply network, for example of a motor vehicle, such as a battery, and to make the connection with a measurement circuit designed to supply temperature information.

In one aspect according to the invention, each connecting member is designed to fit-together with a complementary connector comprising a complementary electrically conductive member that complements said connecting member, said complementary connector being, for example, a plug.

In one aspect according to the invention, the electrical connector is designed to fit-together with a complementary connector comprising at least two complementary electrically conductive members which are configured to connect with the connecting members of the electrical connector.

In one aspect according to the invention, the electrical connector is designed to fit-together with a complementary connector comprising at least four complementary electrically conductive members which are configured to connect with the connecting members of the electrical connector.

In one aspect according to the invention, the connecting members are of the male type and are configured to fit-together with complementary electrically conductive members of the female type belonging to the at least one complementary electrical connector.

In one aspect according to the invention, the connecting members are of the female type and are configured to fit-together with complementary electrically conductive members of the male type belonging to the at least one complementary electrical connector.

In one aspect according to the invention, the at least two distribution electrodes are separated by a spacing, said spacing decreasing with increasing proximity to the electrical-contact regions of the electrical connector.

In one aspect according to the invention, at least one of the distribution electrodes comprises at least one direction-change bend such that the spacing between the distribution electrodes decreases with increasing proximity to the electrical connector.

In one aspect according to the invention, each of the distribution electrodes comprises at least one direction-change bend such that the spacing between the distribution electrodes decreases with increasing proximity to the electrical connector.

In one aspect according to the invention, at least one of the electrodes comprises at least two bends such that the spacing between the distribution electrodes decreases with increasing proximity to the electrical connector.

In one aspect according to the invention, each of the electrodes comprises at least two bends such that the spacing between the distribution electrodes decreases with increasing proximity to the electrical connector.

In one aspect according to the invention, the electrical connector comprises at least two receptacles, one of the receptacles being configured to cover a portion of one of the distribution electrodes, the other receptacle being configured to cover a portion of the other distribution electrode, said receptacles each comprising:
at least a leading edge intended to face said distribution electrodes,
connecting teeth configured to pass through the distribution electrodes, said teeth constituting the electrical-contact regions of the electrical connector,
a connecting member projecting from one of the edges of said receptacles other than the leading edge, said connecting member being configured to connect with a complementary electrically conductive member belonging to a complementary electrical connector,
the leading edge of the receptacle having a profile that is curved over the width of said receptacle.

The curved profile of the leading edge notably limits the risk of cracks and breaks forming in the distribution electrode perpendicular to the direction of circulation of the current.

In one aspect according to the invention, the edge of the electrical connector extends from one of the receptacles to the other receptacle.

In one aspect according to the invention, the electrical connector comprises four receptacles, one of the receptacles being configured to cover a portion of one of the distribution electrodes, another receptacle being configured to cover a portion of the other distribution electrode, another receptacle being configured to cover a portion of an electrical terminal of the temperature sensor, and another receptacle being configured to cover the other electrical terminal of the temperature sensor, said receptacles each comprising:
at least a leading edge intended to face said distribution electrodes, or said electrical terminals of the electric sensor,
connecting teeth configured to pass through the distribution electrodes or the electrical terminals of the temperature sensor, said teeth constituting the electrical-contact regions of the electrical connector,
a connecting member projecting from one of the edges of said receptacles other than the leading edge,
the leading edge of the receptacle having a profile that is curved over the width of said receptacle.

In one aspect according to the invention, the connecting member is configured to connect with a complementary electrically conductive member belonging to a complementary electrical connector.

In one aspect according to the invention, the electrical connector extends along the entirety of said receptacles, so that all of the receptacles are comprised in the connector.

In one aspect according to the invention, the electrical connector comprises at least two clamping regions, one of the clamping regions being configured to clamp one of the distribution electrodes, the other clamping region being configured to clamp the other distribution electrode, each clamping region comprising a first clamping part and a second clamping part which are secured to one another,

at least one of the first clamping part and second clamping part of one of the clamping regions comprising at least one contact portion for contact with a distribution electrode, this contact portion constituting an electrical-contact region of the electrical connector,
the first clamping part and second clamping part being configured to clamp the distribution electrode and establish electrical contact between said distribution electrode and at least one of the first clamping part or second clamping part,
at least one of the first clamping part and second clamping part of the other of the clamping regions comprising at least one contact portion for contact with the other distribution electrode, this contact portion constituting another electrical-contact region of the electrical connector,
the first clamping part and second clamping part being configured to clamp the other distribution electrode and establish electrical contact between said distribution electrode and at least one of the first clamping part or second clamping part.

In one aspect according to the invention, the edge of the electrical connector extends from the first clamping region to the second clamping region.

In one aspect according to the invention, the electrical connector comprises at least four clamping regions, one of the clamping regions being configured to clamp one of the distribution electrodes, another clamping region being configured to clamp the other distribution electrode, another of the clamping regions being configured to clamp one of the electrical terminals of the temperature sensor, another clamping region being configured to clamp the other electrical terminal of the temperature sensor, each clamping region comprising a first clamping part and a second clamping part which are secured to one another,

at least one of the first clamping part and second clamping part of one of the clamping regions comprising at least one contact portion for contact with a distribution electrode, this contact portion constituting an electrical-contact region of the electrical connector,
the first clamping part and second clamping part being configured to clamp the distribution electrode and establish electrical contact between said distribution electrode and at least one of the first clamping part or second clamping part, at least one of the first clamping part and second clamping part of another of the clamping regions comprising at least one contact portion for contact with the other distribution electrode, this contact portion constituting another electrical-contact region of the electrical connector,
the first clamping part and second clamping part being configured to clamp the other distribution electrode and establish electrical contact between said distribution electrode and at least one of the first clamping part or second clamping part,
at least one of the first clamping part and second clamping part of another of the clamping regions comprising at least one contact portion for contact with an electrical terminal of the temperature sensor, this contact portion constituting another electrical-contact region of the electrical connector,
the first clamping part and second clamping part being configured to clamp said electrical terminal of the temperature sensor and establish electrical contact between said electrical terminal of the temperature sensor and at least one of the first clamping part or second clamping part,
at least one of the first clamping part and second clamping part of another of the clamping regions comprising at least one contact portion for contact with the other electrical terminal of the temperature sensor, this contact portion constituting another electrical-contact region of the electrical connector,
the first clamping part and second clamping part being configured to clamp said electrical terminal of the temperature sensor and establish electrical contact between said electrical terminal of the temperature sensor and at least one of the first clamping part or second clamping part.

In one aspect according to the invention, the edge of the electrical connector extends all along the clamping regions.

In one aspect according to the invention, at least one of the distribution electrodes is configured to withstand a voltage less than or equal to 48 V, preferably equal to 12 V.

In one aspect according to the invention, at least one of the electrical terminals of the temperature sensor is configured to withstand a voltage less than or equal to 5 V, preferably equal to 3.3 V.

### BRIEF DESCRIPTION OF THE DRAWINGS

Further features, details and advantages of the invention will emerge upon reading the description given below by way of indication with reference to the drawings, in which:

FIG. 1 is a schematic illustration of one exemplary embodiment of a radiant panel comprised in a heating device according to one exemplary embodiment of the invention;

FIG. 2 is a schematic illustration of components including the radiant panel of the invention;

FIG. 3 is a schematic illustration of another heating structure comprised in the heating device according to the invention;

FIG. 4 is a schematic illustration of another heating structure comprised in the heating device according to the invention;

FIG. 5 is a schematic illustration of another heating structure comprised in the heating device according to the invention;

FIG. 6 is a schematic illustration of another heating structure comprised in the heating device according to the invention;

FIG. 7 is a schematic illustration of another heating structure comprised in a heating device according to the invention;

FIG. 8 is a schematic illustration of another heating structure comprised in a heating device according to the invention;

FIG. 9 is a schematic illustration of another heating structure comprised in a heating device according to the invention;

FIG. 10 illustrates a heating device according to the invention comprising a heating structure like the one illustrated in FIG. 1 and an electrical connector;

FIG. 11 illustrates a heating device according to the invention comprising a heating structure like the one illustrated in FIG. 3 and an electrical connector;

FIG. 12 illustrates a heating device according to the invention comprising a heating structure like the one illustrated in FIG. 1 comprising a temperature sensor like the one illustrated in FIGS. 5 and 6, said device also comprising an electrical connector;

FIG. 13 illustrates the connection between the electrical connector of the device according to the invention, at least one complementary connector and the distribution electrodes of the heating structure of the device according to the invention as illustrated in FIG. 10 or in FIG. 11;

FIGS. 14 and 15 are illustrations of one particular embodiment in which the electrical connector comprises two receptacles,

FIGS. 16 and 17 are illustrations of one particular embodiment in which the electrical connector comprises two clamping regions.

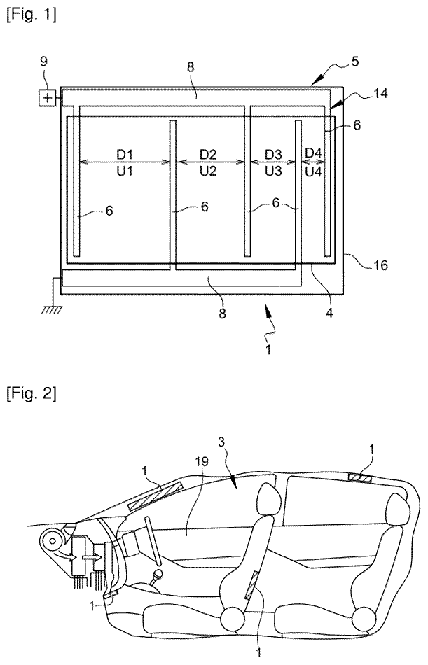

FIG. 1 shows a radiant panel 1 forming a heating structure of a heating device in the sense of the invention, designed to be installed inside a vehicle interior 3.

The radiant panel 1 comprises a resistive layer 4 which is designed to produce a release of heat when this layer 4 has an electric current passing through it.

The resistive layer 4 is, for example, an acrylic paint filled with conductive or semiconductive particles. The conductive filler takes the form of carbon and graphite flakes for example.

This panel 1 also comprises an electrode array 5 comprising a plurality of contact electrodes 6 which are arranged to be in electrical contact with the resistive layer 4 in order to cause electric current to flow through this resistive layer 4.

These contact electrodes 6 are arranged with an inter-electrode distance D1, D2, . . . Di between successive electrodes, which inter-electrode distance is variable.

These contact electrodes 6 are rectilinear and mutually parallel in the example described.

The electrode array 5 comprises distribution electrodes 8 designed to conduct electric current, to the contact electrodes 6, one of these electrodes 8 being connected to an electrical source 9, for example of positive electrical polarity. The other distribution electrode 8 is connected to the other polarity, for example being connected to earth potential.

The electric current thus flows through a distribution electrode 8 which distributes it into the contact electrodes 6. The current then flows in the resistive layer 4 before being collected by the contact electrodes 6 connected to the other distribution electrode 8.

Several contact electrodes 6 are connected to one and the same distribution electrode 8.

The distribution electrodes 8 are rectilinear over part of their length, even over their entire length, and the contact electrodes 6 associated with these distribution electrodes 8 are connected perpendicularly to this associated distribution electrode 8.

Here, the electrode array 5 comprises two mutually parallel distribution electrodes 8, and their associated contact electrodes 6 are arranged between these two distribution electrodes 8 and alternate with an inter-electrode distance D1, D2, . . . Di, which decreases in accordance with the decrease in voltage U1, U2, . . . Ui present between the pairs of electrodes 6, so as to maintain a substantially uniform electrical power between the pairs of contact electrodes.

The contact electrodes 6 arranged between the two distribution electrodes 8, these contact electrodes forming part of one and the same group 14 of contact electrodes, have a plurality of inter-electrode distance values D1, D2, . . . Di. In the example described, D1>D2>D3>D4, and U1>U2>U3>U4 for the voltages between the electrodes 6.

The resistive layer 4 is a layer deposited on a substrate 16, in particular by screen printing, this resistive layer 4 extending in particular between the two distribution electrodes 8 associated with the group of contact electrodes.

The electrodes 6 and 8 are made of conductive material, in particular metallic material, such as ink filled with conductive particles, in particular particles of silver or of copper.

In the example described, the resistive layer 4 associated with the group of contact electrodes is a continuous, substantially rectangular layer. Other shapes are naturally conceivable.

The contact electrodes 6 of one and the same group 14 have the same length. As a variant, the electrodes 6 may have different lengths.

In an example which is not shown, several pairs of distribution electrodes 8 may be provided, and there are then several groups 14 of contact electrodes 6.

A vehicle-interior component 19 of a motor vehicle, in particular a component to be integrated into a door of the vehicle, is provided with a radiant panel 1. Several components may be provided in the vehicle interior.

The component 19 may comprise a decorative layer applied to the radiant panel. The decorative layer may for example be impermeable to air, for example being made of leather.

The distribution electrodes 8 may, if desired, have more complex shapes, with for example one or more rounded bends connecting rectilinear portions.

In the example described, all the inter-electrode distance values Ui of a group 15 are different. As a variant, it is possible that certain inter-electrode distance values of one and the same group are identical, and not all different.

The substrate may be a sheet or a cloth for example.

The contact electrodes 6 and their associated distribution electrodes 8 are arranged in the manner of enmeshed combs.

In a variant, the heating structure is used in a vehicle-interior component, being a passenger armrest, this structure being able to warm the arm of a passenger through thermal contact.

In the example described, the substrate 16 is stretchable. In particular, the elements of the heating structure form a stretchable assembly, in other words the substrate 16, the resistive layer 4 and the contact electrodes 6 are stretchable and flexible.

The contact electrodes 6 are formed by intermeshed, in particular woven or knitted, filaments, on a respectively woven or knitted substrate 16.

The conductive filaments forming the contact electrodes 6 are in contact with the resistive layer 4.

In another example of the invention, the substrate is a non-woven. This non-woven may comprise a mixture of polypropylene fibres and/or polyester fibres. Other fibres may be used, for example natural fibres.

As a variant, the substrate 16 is a fabric, in particular with stretchable filaments, or a knitted structure.

According to one of the aspects of the invention, the substrate may be a flexible plastic sheet or a foam such as TPU (thermoplastic polyurethane) foam.

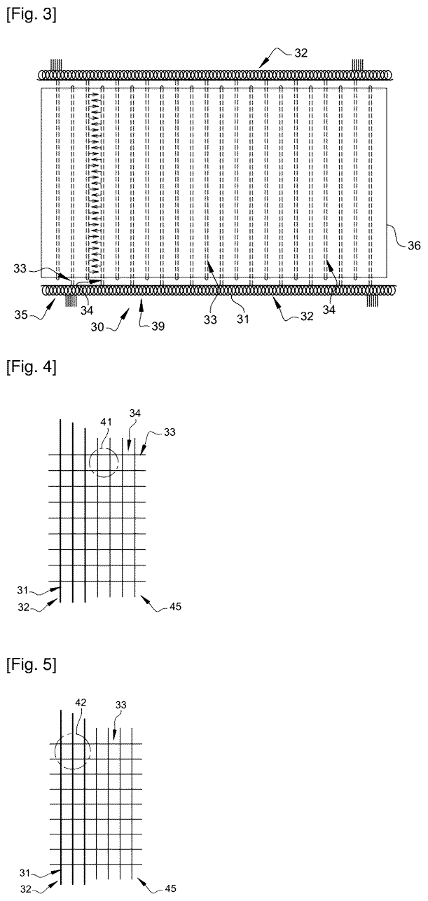

FIG. 3 shows a heating structure 30 intended in particular to be installed inside a vehicle interior, this structure being a radiant panel, the heating structure comprising a set of intermeshed filaments, of which certain filaments 31 form distribution electrodes 32, also called busbars, and other intermeshed filaments 33 form contact electrodes 34.

The substrate 35 on which the electrodes 32 and 34 are formed is here a knitted structure 35 which incorporates filaments used as contact electrodes and the resistive layer 36 is placed on the surface. The resistive ink is attached, for example, to the textile by lamination, screen printing or hot stamping and transfer.

The substrate 35 comprises at least one of the following filaments: non-stretchable filaments for the substrate, non-stretchable conductive filaments for electrodes, single-stranded or multi-stranded copper filaments, a copper conductive filament, and non-conductive filaments for reasons of mechanical strength or ease of manufacture.

The heating structure 30 comprises an electrical distribution circuit 39 comprising distribution electrodes 32 which carry the current from the connectors to the contact electrodes 34 which are in contact, for example, with a resistive layer.

The contact electrodes 34 and distribution electrodes 32 are, for example, made of copper filaments.

When the substrate 35 is knitted, the stretchable characteristic may be obtained either through the arrangement of the knitted structure, namely through the knitting technique, or through the intrinsic stretchability of the filaments used for the knitting.

In particular, if the extensibility of the conductive filament is different from that of the main fibres of the knit, the end of each conductor must remain free to move inside or outside the knit.

Let A be the number of contact electrodes 34 connecting to one of the distribution electrodes 32 and B the number of filaments used for each contact electrode; the distribution electrodes thus have AxB knitted filaments. The knitted filaments of the distribution electrodes are knitted so as to form connecting elements too.

In order to have a continuous manufacturing process for the knitted or woven structure, it is possible to connect the two sides of the contact electrodes 34 to the distribution electrodes 32 and then to electrically neutralize a portion of these contact electrodes with respect to the distribution electrode by cutting the filaments of the contact electrodes by stamping them, as represented by the regions 41 in FIG. 4, or by incorporating an electrical insulator into a region 42 illustrated in FIG. 5, at the location where the electrical connection must be interrupted. FIGS. 4 and 5 show woven substrates 45.

It is possible to have a connector at the end of each contact electrode 36, or an external distribution electrode connecting all of the contact electrodes together.

The filaments used for the distribution electrodes have a larger diameter than the filaments used to form the contact electrodes, or heating filaments.

In the case of the use of heating filaments, it is not mandatory to have a resistive layer, for example a coat of resistive ink.

If a plurality of contact electrodes 34 are connected together to one of the distribution electrodes 32, as shown in FIG. 3, the connection between the distribution electrode 32 and the contact electrodes 34 may be made by integrating the distribution electrode into the weaving weft and the contact electrodes into the weaving warp or vice versa. By virtue of an alternating passage on the two sides of the woven structure, the connection between electrodes is secure.

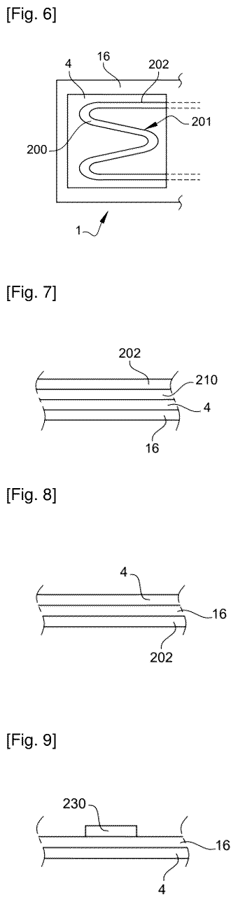

FIG. 6 shows an exemplary embodiment of the invention in which the heating structure 1 comprises a temperature sensor 200 rigidly secured to the substrate 16 and designed to contribute to measuring the temperature of at least one region 201 of the heating structure 1.

The temperature sensor 200 has an electrical resistance which varies as a function of temperature. Thus, the temperature sensor 200 is arranged to allow access to a measurement of temperature in said region of the heating structure 1 by measuring the electrical resistance of the temperature sensor 200, which resistance is a function of the temperature in said region 201 of the heating structure.

The temperature sensor 200 comprises a measurement layer 202 extending in the region 201 where the temperature is to be measured, and this measurement layer 202 has an electrical resistance which is variable as a function of the temperature of the region.

According to one of the aspects of the invention, this measurement layer 202 is made of a material with an NTC (negative temperature coefficient) effect or a material with a PTC (positive temperature coefficient) effect.

According to one of the aspects of the invention, the NTC material has the feature whereby its electrical resistance drops when the temperature increases. The material may comprise, for example, a semiconductive silicone.

According to one of the aspects of the invention, the PTC material has the feature whereby its electrical resistance increases when the temperature increases. In particular, the increase in resistance may jump when a threshold temperature is reached. The PTC material may for example comprise a carbon-based paint.

The measurement layer 202 covers at least 10%, in particular at least 20%, or 30% or 40% of the surface area of the heating structure, in particular of the surface area of the substrate 16.

The measurement layer 202 extends over a region 201 of the heating structure which is likely to heat up, in particular the measurement layer is arranged in thermal interaction with the resistive layer in such a way as to measure the temperature of at least some regions of this resistive layer 4.

The measurement layer 202, which is a surface layer, extends mainly facing the resistive layer, in particular over at least 90% of the surface area of the measurement layer.

The measurement layer 202 has a thickness of between 40 and 200 microns.

The measurement layer 202 has a shape selected for measuring the temperature of the resistive layer in regions likely to heat up the most in the operation of this resistive layer.

The measurement layer 202 has a serpentine shape.

The invention provides a method for controlling the temperature of a resistive layer, in the case where a PTC material is used to form the temperature sensor 200 in thermal interaction with the resistive layer, the method comprising the step of detecting when a temperature threshold (Tc) is exceeded locally or globally on the resistive layer 4 and, starting from this threshold, activating, if necessary, temperature regulation, wherein this regulation may be chosen from cutting the power supply, PWM regulation, reduction of the supply voltage in particular.

The invention also relates to a method for controlling the temperature of a resistive layer, in the case where an NTC material is used to form the temperature sensor in thermal interaction with the resistive layer, the method comprising the steps of measuring the overall temperature of the panel and controlling the power supply to the panel, in particular in real time, as a function of the average temperature observed.

As can be seen in FIG. 7, the temperature sensor 200 comprises a measurement layer 202 electrically insulated from the resistive layer 4 carried by the substrate 16, by an insulating layer or an insulating sheet 210. There are therefore, in the following order: the substrate 16 as described above, for example non-woven, the resistive layer 4, the insulating layer 210 and the measurement layer 202. In this case, the resistive layer 4 and the temperature sensor 202 are present on one and the same face of the substrate 16.

According to one of the aspects of the invention, the heating structure comprises a substrate 16, in particular a textile, thermoplastic, non-woven substrate, on which is present the measurement layer produced in particular by printing, screen printing or lamination of a material, in particular a PTC or NTC material.

As a variant, the measurement layer 202 comprises a film of material, in particular a laminated material.

As a further variant, the heating structure comprises a textile substrate 16, in particular woven or knitted, on which filaments having NTC or PTC properties are knitted/embroidered/sewn.

According to one of the aspects of the invention, as shown in FIG. 8, the resistive layer is present on one face of the substrate 16, and the temperature sensor 200 is present on an opposite face of the substrate 16. In this case, it is not necessary to have an insulating layer since the substrate, for example non-woven, is here an insulating layer designed to insulate the resistive layer 4 from the temperature sensor 202.

As shown in FIG. 9, as a variant, the temperature sensor comprises a thermocouple 230, or in particular a temperature probe formed by an added component, this sensor being designed to be placed on the substrate 16 on an opposite face to the resistive layer 4.

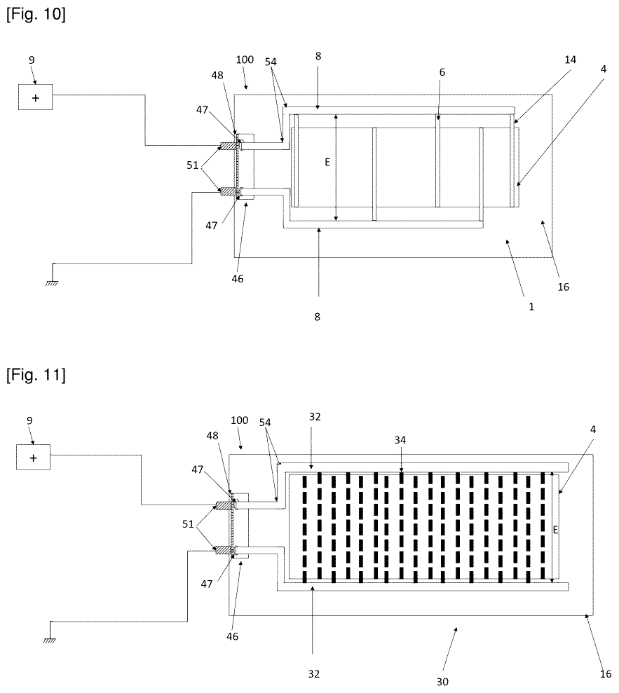

FIG. 10 shows a heating device 100 according to the invention. The heating device 100 comprises a heating structure 1 which is a radiant panel like the one illustrated in FIG. 1, and an electrical connector 46.

The heating structure 1 in this example comprises all of the features described in respect of the heating structure illustrated in FIG. 1.

The distribution electrodes 8 are designed to conduct electric current to the contact electrodes 6, one of these distribution electrodes 8 being connected to an electrical source 9, for example of positive electrical polarity. The other distribution electrode 8 is connected to the other polarity, for example being connected to earth potential.

The heating device 100 comprises an electrical connector 46 configured to connect the distribution electrodes 8.

The electrical connector 46 is configured to connect one of the distribution electrodes 8 to the electrical source 9, and the other distribution electrode 8 to the other polarity which is notably connected to earth potential.

The electrical connector 46 here comprises two electrical-contact regions 47, each of these electrical-contact regions 47 being configured to be in contact with each of the distribution electrodes 8.

One of the electrical-contact regions 47 of the electrical connector 46 is in electrical contact with the electrical source 9, and the other electrical-contact region 47 is in electrical contact with the other polarity which is notably connected to earth potential.

In this way, the electrical connector 46 is configured to connect one of the distribution electrodes 8 with the electrical source 9 via one of the electrical-contact regions 47, and the other distribution electrode 8 with the other polarity, which is notably connected to earth potential, via the other electrical-contact region 47.

The electrical connector 46 is configured to fit-together with at least one complementary connector 51. This connection is best detailed in FIG. 13.

In this example, the electrical connector 46 is connected to two complementary connectors 51 for example of the plug type. In this way, the electrical connector 46 is connected to the electrical source 9 and to earth potential via these complementary connectors 51.

The electric current thus passes into one of the distribution electrodes 8 via one of the electrical-contact regions 47 of the electrical connector 46 connected to a complementary connector 51 connected to the electrical source 9. Said distribution electrode 8 distributes the electric current to the contact electrodes 6. The current then flows in the resistive layer 4 before being collected by the contact electrodes 6 connected to the other distribution electrode 8. The current then flows towards the other polarity, notably connected to earth potential, via the other complementary connector 51 connected to the other electrical-contact region 47 of the electrical connector 46.

The electrical connector 46 has an edge 48 which extends from one of the electrical-contact regions 47 towards the other electrical-contact region 47. The electrical connector 46 therefore comprises all of the electrical-contact regions 47. In this way, only one electrical connector 46 is needed for connecting the distribution electrodes 8.

In this example, the electrical connector 46 is mounted on the heating structure 1. More particularly, in this example, the electrical connector 46 is carried by the substrate 16.

The distribution electrodes 8 here comprise two bends 54 such that the spacing E decreases with increasing proximity to the electrical-contact regions 47 of the electrical connector 46. In this way, there is no need to have a large-sized electrical connector 46 in order to connect all of the electrical-contact regions 47 to the distribution electrodes 8.

In another embodiment not illustrated here, it is possible for just one of the two distribution electrodes 8 to comprise two bends 54, such that the spacing E between the two distribution electrodes 8 decreases with increasing proximity to the electrical-contact regions 47 of the electrical connector 46.

In another embodiment not illustrated here, it is possible for each of the electrodes 8 to comprise a single direction-change bend 54, such that the spacing E between the two distribution electrodes 8 decreases with increasing proximity to the electrical-contact regions 47 of the electrical connector 46.

The electrical connector 46 may be mounted anywhere on the heating surface 1.

FIG. 11 illustrates a heating device comprising a heating structure 30 like the one illustrated in FIG. 3 and an electrical connector 46.

The heating structure 30 in this example comprises all of the features described in respect of the heating structure 30 illustrated in FIG. 3.

The heating structure 30 comprises a collection of intermeshed filaments of which certain filaments, not illustrated here, form distribution electrodes 32, also called busbars, and other intermeshed filaments, not illustrated here, form contact electrodes 34.

The distribution electrodes 32 are designed to conduct electric current to the contact electrodes 34, one of these electrodes 32 being connected to an electrical source 9, for example of positive electrical polarity. The other distribution electrode 32 is connected to the other polarity, for example being connected to earth potential.

The heating device 100 comprises an electrical connector 46 configured to connect the distribution electrodes 32.

The electrical connector 46 is configured to connect one of the distribution electrodes 32 to the electrical source 9, and the other distribution electrode 32 to the other polarity which is notably connected to earth potential.

The electrical connector 46 here comprises two electrical-contact regions 47, each of these electrical-contact regions 47 being configured to be in contact with each of the distribution electrodes 32.

One of the electrical-contact regions 47 of the electrical connector 46 is in electrical contact with the electrical source 9, and the other electrical-contact region 47 is in electrical contact with the other polarity which is notably connected to earth potential.

In this way, the electrical connector 46 is configured to connect one of the distribution electrodes 32 with the electrical source 9 via one of the electrical-contact regions 47, and the other distribution electrode 32 with the other polarity, which is notably connected to earth potential, via the other electrical-contact region 47.

The electrical connector 46 is configured to fit-together with at least one complementary connector 51. In this example, the electrical connector 46 is connected to two complementary connectors 51 for example of the plug type.

The electric current thus passes into one of the distribution electrodes 32 via one of the electrical-contact regions 47 of the electrical connector 46 connected to a complementary connector 51 connected to the electrical source 9. Said distribution electrode 32 distributes the electric current to the contact electrodes 34. The current then flows in the resistive layer 36 before being collected by the contact electrodes 34 connected to the other distribution electrode 32. The current then flows towards the other polarity, notably connected to earth potential, via the other complementary connector 51 connected to the other electrical-contact region 47 of the electrical connector 46.

In this example, the electrical connector 46 is mounted on the heating structure 30.

The distribution electrodes 32 here comprise two direction-change bends 54 such that the spacing E decreases with increasing proximity to the electrical-contact regions 47 of the electrical connector 46. In this way, there is no need to have a large-sized electrical connector 46 in order to connect all of the electrical-contact regions 47 to the distribution electrodes 32.

In another embodiment not illustrated here, it is possible for just one of the two distribution electrodes 32 to comprise two direction-change bends 54, such that the spacing E between the two distribution electrodes 32 decreases with increasing proximity to the electrical-contact regions 47 of the electrical connector 46.

In another embodiment not illustrated here, it is possible for each of the electrodes to comprise only a single direction-change bend 54, such that the spacing E between the two distribution electrodes decreases with increasing proximity to the electrical-contact regions 47 of the electrical connector 46.

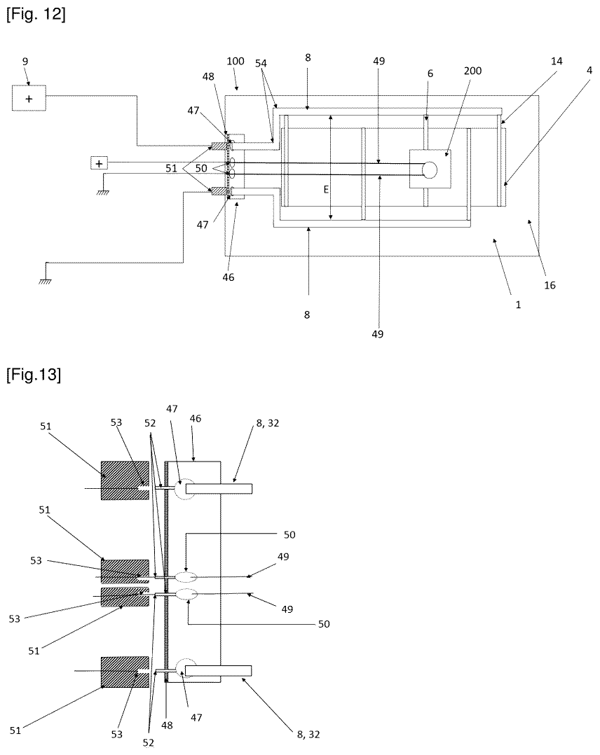

FIG. 12 is an illustration of a heating device 100 as described in FIG. 10, further comprising a temperature sensor 200 configured to contribute to measuring the temperature of at least one region of the heating structure 1.

In one example that is not illustrated here, that which follows applies also to a heating device comprising a heating structure 30 comprising a collection of intermeshed filaments of which certain filaments 31 form distribution electrodes 32, also called busbars, and other intermeshed filaments 33 form contact electrodes 34, as illustrated in FIG. 11.

The temperature sensor 200 comprises all of the features described in FIGS. 6 and 7.

The temperature sensor 200 further comprises two electrical terminals 49 configured to connect the temperature sensor 200 to a measurement circuit designed to supply temperature information. These electrical terminals 49 may in particular be electrically conductive filaments or electrically conductive plates.

The temperature measurement circuit in particular comprises an electrical source of positive polarity and a source of another polarity for example connected to earth potential. One of the electrical terminals 49 is configured to connect the temperature sensor 200 to the electrical source of positive polarity, and the other electrical terminal 49 is configured to connect the temperature sensor 200 to the other polarity, which is notably connected to earth potential.

In this embodiment, the electrical connector 46 comprises two electrical-contact regions 47 for establishing contact with the distribution electrodes 8, and two additional contact regions 50 for establishing contact with the electrical terminals 49 of the temperature sensor 200.

In this way, one of the distribution electrodes 8 is electrically connected to an electrical source 9 of positive polarity, the other distribution electrode is electrically connected to the other polarity, notably connected to earth potential, each of the electrical terminals 49 of the temperature sensor 200 is connected to the measurement circuit designed to supply temperature information.

The electrical connector 46 extends all along the electrical-contact regions 47 and the additional electrical-contact regions 50 or, in other words, the electrical connector 46 is made so that it comprises all of the electrical-contact regions 47 and additional electrical-contact regions 50.

Thus, a single electrical connector 46 is sufficient for connecting the distribution electrodes 8 to an electrical network, in particular a battery, for connecting the electrical terminals 49 of the temperature sensor 200 to the measurement circuit designed to supply temperature information.

In this example, the electrical connector 46 is configured to fit-together with four complementary connectors 51 each comprising a complementary electrically conductive member complementing a connecting member of the electrical connector 46.

In this way, the electric current passes into one of the distribution electrodes 8 via one of the electrical-contact regions 47 of the electrical connector 46 connected to a complementary connector 51 connected to said electrical source, said distribution electrode distributing the electric current to the contact electrodes 6. The current then flows in the resistive layer 4 before being collected by the contact electrodes 34 connected to the other distribution electrode 32. The current then flows towards the other polarity, notably connected to earth potential, via another complementary connector 51 connected to the other electrical-contact region 47 of the electrical connector 46. The electrical terminals 49 of the temperature sensor 200 are connected to a measurement circuit designed to supply temperature information via the additional contact regions 50 of the electrical connector 46 which are connected to other complementary connectors 51 connected to a measurement circuit designed to supply temperature information.

FIG. 13 illustrates the connection between the electrical connector 46 of the device 100 according to the invention and four complementary connectors 51.

That which follows applies as much to a heating device 100 comprising a heating structure as illustrated in FIG. 1 as it does to a heating device 100 comprising a heating structure as illustrated in FIG. 3.

In this example, the electrical connector 46 comprises two contact regions 47, one of the electrical-contact regions 47 being in contact with one of the distribution electrodes 8, 32, the other electrical-contact region 47 being in contact with the other distribution electrode 8, 32, and two additional electrical-contact regions 50, one of the additional electrical-contact regions 50 being in contact with one of the electrical terminals 49 of the temperature sensor, the other additional electrical-contact region being in contact with the other electrical terminal 49 of the temperature sensor 200.

The electrical-contact regions 47 and the additional contact regions 50 are in electrical contact with a connecting element 52 which, here, is of male type.

Each connecting element 52 is configured to fit-together with a complementary electrically conductive element 53 comprised in a complementary connector 51.

The electrical connector 46 is configured to fit-together with at least one complementary connector 51.

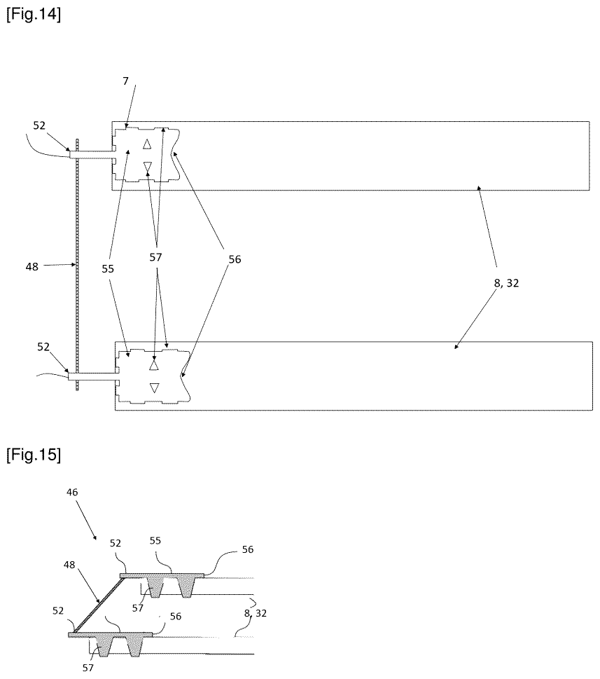

FIGS. 14 and 15 illustrate one particular embodiment in which the device 100 comprises an electrical connector 46 having teeth 57 by way of electrical-contact regions 47.

That which follows applies to a device 100 comprising a heating structure as illustrated in FIG. 1 or in FIG. 3.

In this embodiment, the electrical connector 46 comprises at least two receptacles 55, one of the receptacles 55 being configured to cover a portion of one of the distribution electrodes 8, 32, the other receptacle 55 being configured to cover a portion of the other distribution electrode 8, 32, said receptacles 55 each comprising:
at least a leading edge 56 intended to face said distribution electrodes 8, 32,
connecting teeth 57 configured to pass through the distribution electrodes, said teeth comprising electrical-contact regions 47 of the electrical connector 46,
a connecting member 52 projecting from one of the edges of said receptacles 55 other than the leading edge 56,
the leading edge 56 of the receptacle 55 having a profile that is curved over the width of said receptacle 55.

In order to limit the risk of hot spots forming, the receptacle 55 covers at least 90% of the width of the distribution electrode 8, 32, and those edges 61 of the receptacle 55 which are contiguous with the leading edge 56 each comprise at least one first connecting tooth 57.

The connecting member 52 of each of the receptacles 55 is configured to connect with a complementary electrically conductive member 53 of a complementary connector 51.

The electrical connector 46 is of a size large enough to encompass all of the receptacles 55. All of the receptacles 55 are encompassed in the electrical connector 46.

As can be seen in FIG. 15, the teeth 57 come directly into contact with the distribution electrodes 8, 32 so that part of these teeth 57 comprises a region 47 of electrical contact with the distribution electrode through which region a current passes.

In one example not illustrated here, the electrical connector 46 comprises four receptacles 55 as described above, one of the receptacles 55 being configured to cover a portion of one of the distribution electrodes 8, 32, another receptacle 55 being configured to cover a portion of the other distribution electrode 8, 32, another receptacle 55 being configured to cover a portion of an electrical terminal 49 of the temperature sensor 200, and another receptacle 55 being configured to cover a portion of the other electrical terminal 49 of the temperature sensor 200.

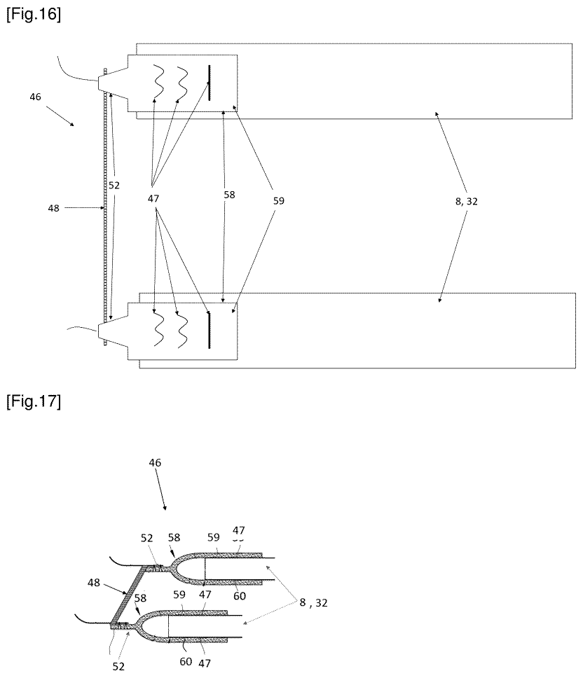

FIGS. 16 and 17 illustrate another embodiment. That which follows applies to the heating devices 100 comprising a heating structure as illustrated in FIG. 1 or in FIG. 3.

In this embodiment, the heating device 100 comprises an electrical connector 46 which comprises two clamping regions 58, one of the clamping regions 58 being configured to clamp one of the distribution electrodes 8, 32, the other clamping region 58 being configured to clamp the other distribution electrode 8, 32, each clamping region 58 comprising a first clamping part 59 and a second clamping part 60 which are secured to one another,

at least one of the first clamping part 59 and second clamping part 60 of one of the clamping regions 58 comprising at least one contact portion 47 for contact with a distribution electrode 8, 32, this contact portion constituting an electrical-contact region 47 of the electrical connector 46,
the first clamping part 59 and second clamping part 60 being configured to clamp the distribution electrode 8, 32 and establish electrical contact between said distribution electrode 8, 32 and at least one of the first clamping part 59 or second clamping part 60,
at least one of the first clamping part 59 and second clamping part 60 of the other of the clamping regions 58 comprising at least one contact portion 47 for contact with the distribution electrode, this contact portion 47 constituting another electrical-contact region 47 of the electrical connector 46,
the first clamping part 59 and second clamping part 60 being configured to clamp the other distribution electrode 8, 32 and establish electrical contact between said distribution electrode 8, 32 and at least one of the first clamping part 59 or second clamping part 60.

The first clamping part 59 and second clamping part 60 here each comprise an electrical-contact region 47 for contact with the distribution electrode 8, 32 to which they are connected.

In an embodiment not illustrated here, it is possible for just one of the first clamping part 59 or second clamping part 60 to comprise an electrical-contact region 47 for contact with the distribution electrode.

In this embodiment, the first and second clamping parts 59, 60 are produced as a single piece.

In this embodiment, the electrical connector 46 comprises a connecting member 52 that protrudes from one edge of the first clamping part 59 and second clamping part 60. This connecting member 52 is configured to ensure connection to the electrical power supply network, of a motor vehicle for example. This connecting member 52 makes it possible to establish electrical connection with, for example, an electric wire crimped directly onto this connecting member. This also allows the electrical connector 46 to be connected to at least one complementary connector 51 comprising a complementary electrically conductive member 53.

The electrical connector 46 is preferably made in one piece, for example by stamping or cutting. The first clamping part 59 and second clamping part 60 and the connecting member 52 may thus all be formed in one and the same manufacturing step.

In this example, the first part 59 has the form of a substantially parallelepipedal flexible blade. The second part 60 (not visible in FIG. 16) also takes this form. The first clamping part 59 and the second clamping part 60 are configured to clamp the distribution electrode 8, 32. Advantageously, the first clamping part 59 covers the entire width of the distribution electrode 8. Thus the electric current is better distributed over the width of the distribution electrode 8, 32 and the risk of hot spots forming is reduced.

In one example not illustrated here, the electrical connector 46 comprises four clamping regions 58 as described previously, one of the clamping regions 58 being configured to clamp one of the distribution electrodes 8, 32, another clamping region 58 being configured to clamp the other distribution electrode 8, 32, another clamping region 58 is configured to clamp one electrical terminal 49 of the temperature sensor 200, another clamping region is configured to clamp the other electrical terminal 49 of the temperature sensor 200, each clamping region 58 comprising a first clamping part 59 and a second clamping part 60 which are secured to one another.

The electrical connector 46 is of a size large enough to encompass all of the clamping regions 58. All of the clamping regions 58 are encompassed in the electrical connector 46.

1. A heating device configured to be installed in a motor vehicle interior,
the heating device comprising:
a heating structure comprising:
at least one resistive layer configured to produce a release of heat when the resistive layer has an electric current passing through it,
at least two distribution electrodes,
wherein the distribution electrodes being are in electrical contact with the resistive layer so as to allow an electric current to flow through the resistive layer; and
an electrical connector comprising at least two electrical-contact regions,
wherein one of the electrical-contact regions is in electrical contact with one of the distribution electrodes,
wherein the other electrical-contact region is in contact with the other distribution electrode,
the electrical connector comprising an edge extending from one of the electrical-contact regions towards the other electrical-contact region.

2. The heating device according to claim 1,
wherein the electrical connector is mounted on the heating structure.

3. The heating device according to claim 1,
wherein the electrical connector is made in one piece.

4. The heating device according to claim 1,
wherein the heating structure comprises a temperature sensor configured to contribute to measuring the temperature of at least one region of the heating structure.

5. The heating device according to claim 4,
wherein the temperature sensor comprises at least two electrical terminals configured to connect the temperature sensor to a measurement circuit configured to supply temperature information.

6. The heating device according to claim 5,
wherein the electrical connector comprises at least two additional electrical-contact regions,
wherein one of the additional electrical-contact regions is in contact with one of the electrical terminals of the temperature sensor, and the other additional electrical-contact region is in electrical contact with the other electrical terminal of the temperature sensor.

7. The heating device according to claim 1,
wherein the electrical connector is configured to fit-together with at least one complementary connector that complements the electrical connector,
wherein the complementary connector is, a plug.

8. The heating device according to claim 1,
wherein the at least two distribution electrodes are separated by a spacing,
wherein the spacing decreases with increasing proximity to the electrical-contact regions of the electrical connector.

9. The heating device according to claim 1,
wherein at least one of the distribution electrodes comprises at least one direction-change bend such that the spacing between the distribution electrodes decreases with increasing proximity to the electrical connector.

10. The heating device according to claim 1,
wherein the electrical connector comprises at least two clamping regions,
wherein one of the clamping regions is configured to clamp one of the distribution electrodes,
wherein the other clamping region being is configured to clamp the other distribution electrode,
each clamping region comprising a first clamping part and a second clamping part which are secured to one another,
at least one of the first clamping part and second clamping part of one of the clamping regions comprising at least one contact portion for contact with a distribution electrode,
wherein the contact portion constitutes an electrical-contact region of the electrical connector,
wherein the first clamping part and second clamping part are configured to clamp the distribution electrode and establish electrical contact between the distribution electrode and at least one of the first clamping part or second clamping part,
at least one of the first clamping part and second clamping part of the other of the clamping regions comprising at least one contact portion for contact with the other distribution electrode,
wherein the contact portion constitutes another electrical-contact region of the electrical connector,
wherein the first clamping part and second clamping part are configured to clamp the other distribution electrode and establish electrical contact between the distribution electrode and at least one of the first clamping part or second clamping part.
